(19) United States
(12) Patent Application Publication
(10) Pub. No.: US 2023/0011572 A1
(43) Pub. Date: Jan. 12, 2023

(54) WIRELESS CONTROLLER

(71) Applicant: Bose Corporation, Framingham, MA (US)

(72) Inventors: Neal Anderson, Northborough, MA (US); John Leslie Benton, Northbridge, MA (US); Santiago Carvajal, Ashland, MA (US); Thomas D. Chambers, Bellingham, MA (US); Fardad Faridi, Marlborough, MA (US); John Lloyd Goodman, Bellingham, MA (US); Joel H. Miller, Westborough, MA (US); Richard O'Day, Westborough, MA (US); Todd R. Reily, North Reading, MA (US); Christopher D. Vincent, Needham, MA (US)

(21) Appl. No.: 17/370,363

(22) Filed: Jul. 8, 2021

(51) Int. Cl. G06F 3/01; H01Q 1/42; G06F 3/03

(52) U.S. Cl. CPC G06F 3/016; H01Q 1/42; G06F 3/017; G06F 3/0321

(57) ABSTRACT

Systems and methods for a wireless controller are provided. The wireless controller includes an enclosure having a top and a bottom, each having a substantially circular perimeter, and a side having a height circumferentially around the perimeter of the top and the bottom. A first sensor is configured to detect movement of the enclosure. A processor is coupled to the first sensor and configured to process signals from the first sensor and to send command signals via a wireless interface based at least upon the signals from the first sensor.

### BACKGROUND

Various audio peripherals such as headphones, ear buds, open ear wearables, portable speakers, and fixed speakers such as soundbars and other home audio speaker systems are increasingly available to couple with smart devices (e.g., phones, tablets, laptops, etc.). In a typical use case, these audio peripherals (and in various instances, video peripherals) may couple wirelessly to the smart device, such as through any of various Wi-Fi (e.g., various IEEE 802.11 protocols) and/or Bluetooth protocols, or others. In various applications, the smart device may be a source of an audio (and/or video) content and the peripheral may be a sink of the audio (and/or video) content.

Conventional systems require a user to interact directly with controls or user input functionality at either of the peripheral or the smart device. For example, playback controls (e.g., volume control, play/pause, mute, skip, back, etc.) may be available to the user only by interacting directly with either the source device (e.g., the smart device) or the sink device (e.g., the peripheral). In some examples, the smart device may include speakers and/or displays to render audio and/or video content itself, without a peripheral device. There exists a need for other options to remotely control various functions without having to physically go to the smart device (or the peripheral device), or to allow a user to place such controls wherever desired, thus allowing the user to leave the smart device (content source) and/or any peripheral device (content sink) in any desirable location, e.g., which may be out of convenient reach of the user.

### SUMMARY

Systems and methods disclosed herein are directed to wireless remote control of various smart devices. The wireless remote control, or simply wireless controller, couples to the smart device via at least one of any of various wireless protocols, such as various Wi-Fi, Bluetooth, or other protocols. In various applications, the wireless controller may provide user interface functionality, via various sensors that detect user manipulation of the wireless controller, to control audio and video content, especially playback of audio and video content, on the smart device (content source). Such controls may include volume controls, play/pause, mute, skip, back, and others. Accordingly, systems and methods disclosed are directed to remote control systems and methods and audio systems and methods that inter-operate with other devices, such as a mobile device, smart phone, tablet, etc.

According to at least one aspect, a wireless controller is provided that includes an enclosure having a top and a bottom, each of the top and the bottom having a substantially circular perimeter, and a side having a height circumferentially around the perimeter of the top and the bottom and coupling the top with the bottom, a first sensor configured to detect movement of the enclosure, a processor coupled to the first sensor and configured to process signals from the first sensor, and a wireless interface coupled to the processor, the processor further configured to control the wireless interface to send one or more command signals via the wireless interface, the command signals based at least upon the signals from the first sensor.

In some examples, the first sensor includes at least one of an inertial measurement unit (IMU), an accelerometer, a gyroscope, a gravitometer, and a magnetometer, and the detected movement includes at least one of a rotation and a translation.

Various examples include a material coupled to the bottom and configured to provide a coefficient of friction with a surface in contact with the material. In some examples, the material is configured to provide a specified range of coefficient of friction, while in certain examples the material is configured to provide a specific coefficient of friction.

According to some examples, the wireless controller device may include a wall plate configured to accommodate and removably couple with the bottom. In certain examples, a magnet may provide or enable the removable coupling.

Various examples may include a second sensor configured to detect contact with at least one of the top, bottom, and side by a user, the processor further configured to process signals from the second sensor and to control the wireless interface to send command signals based at least upon the signals from the second sensor. In some examples, the second sensor may be at least one of a capacitive touch sensor and a force sensor. In some examples, the second sensor may detect an amount of force exerted by the user via at least one of an inductance sensor, a capacitance sensor, a micro electro-mechanical system (MEMS), and a piezoelectric sensor.

In various examples, the command signals may be based at least upon a detected gesture by the user.

According to various examples, the command signals include one or more of pause, play, skip forward, skip backward, volume up, volume down, mute, and initiate pairing.

Some examples may include a vibration device coupled to the processor, the processor further configured to control the vibration device to provide haptic feedback to the user. In certain examples the haptic feedback to the user includes at least a perceived detent in response to rotation.

In various examples the processor is configured to initiate a wireless connection by monitoring the wireless interface for a nearby device based upon a signal strength of one or more wireless signals between the wireless interface and the nearby device. According to certain examples. the nearby device may be selected by the processor as a device having the highest signal strength. In some examples the signal strength is indicated by a wireless message that includes a received signal strength indicator (RSSI). In various examples the processor may be configured to initiate the wireless connection in response to at least one of a detected user gesture, a detected proximity to the nearby device, a power-on event, a detected lack of configuration settings, and a detected physical contact with the nearby device.

According to at least one example, the wireless controller device may include an infrared (IR) interface coupled to the processor and configured to send or receive infrared signals.

In certain examples, the processor may be configured to determine a gyroscopic stability of a detected movement and to control the wireless interface to send the one or more command signals based upon the determination.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a schematic perspective view of an example wireless controller;

FIG. 2 is a perspective view of the wireless controller of FIG. 1; and

FIG. 3 is a schematic view of an example system architecture of the wireless controller of FIG. 1.

### DETAILED DESCRIPTION

Aspects of the present disclosure are directed to systems and methods to remotely, wirelessly control various devices and/or peripherals. In a general use case, a wireless controller in accord with those described herein may be coupled via Bluetooth, including via Bluetooth Low Energy (BLE), to a controlled device, such as a smart phone, tablet, etc. The wireless controller may detect various user interaction with the wireless controller and, based upon the user interaction, send control information to the controlled device. In some examples, the wireless controller may also include user feedback capabilities.

In various examples, the controlled device may be an audio and/or video content source. In some examples, the controlled device may be an audio and/or video content sink or peripheral.

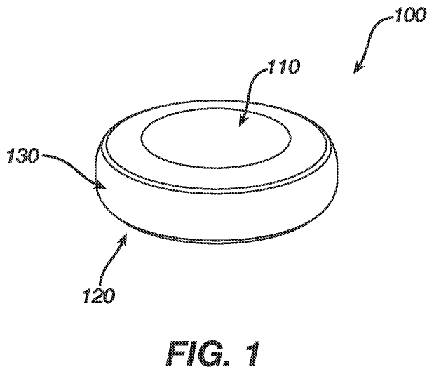

FIG. 1 illustrates an example wireless controller 100. The wireless controller 100 includes an enclosure having a top surface 110, a bottom surface 120, and a side 130. In various examples, each of the top surface 110 and the bottom surface 120 may be substantially circular, e.g., having substantially circular perimeters. In various examples, the side 130 may circumferentially surround the substantially circular perimeters of the top surface 110 and the bottom surface 120. The side 130 has a height that may substantially define the overall “height” of the wireless controller 100, plus or minus any ‘dome’ or other non-flat surface structure(s) of the top surface 110 and the bottom surface 120.

In various examples, the overall wireless controller 100 is substantially circular, having a height, and may thereby be “puck” shaped. The circular or puck form factor allows for easy rotation of the wireless controller 100 about a central axis, such as by a user interacting with the wireless controller to rotate it, whether on a surface or being held in the air.

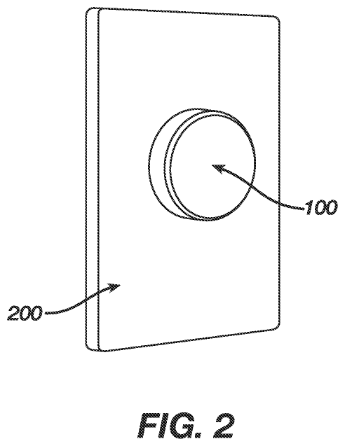

In various use cases, the wireless controller 100 may be used in various orientations and in contact with various surfaces (or no surfaces). For example, the wireless controller 100 may be placed on a flat horizontal surface, such as a desk or table. In another use case, and as illustrated by FIG. 2, the wireless controller 100 may be “mounted” on a vertical surface and may include (or be coupled to) a wall plate, such as an example wall plate 200 of FIG. 2. In some examples, each of the wireless controller 100 and the wall plate 200 may include at least one of a magnet and/or a material that responds to magnetic fields, such that when the wireless controller 100 is brought into proximity with the wall plate 200, the magnetic features exert a magnetic force to retain the wireless controller 100 against the wall plate 200. The wall plate 200 may be mounted to a wall, for example, and the magnetic force retains the wireless controller 100 despite there being no physical support underneath the wireless controller 100. Because the wireless controller 100 may be used horizontally, vertically, or in other orientations, the above references to ‘top,’ ‘bottom,’ and ‘height’ are for convenience of description only, and are with reference to what would be a horizontal use orientation, and are not meant to be limiting.

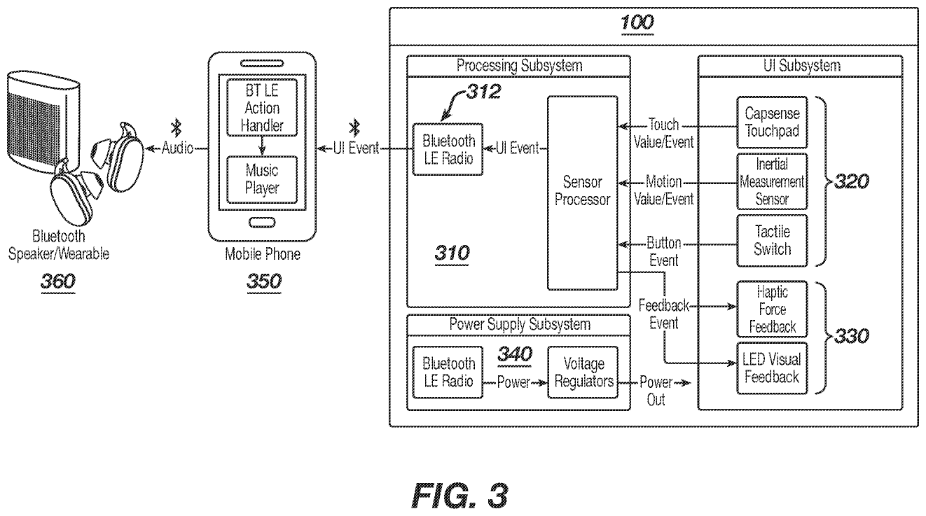

A user may interact with the wireless controller 100 in various ways, such as by rotating, touching, tapping, or swiping on its various surfaces, as well as other interactions. The wireless controller 100 includes one or more processors and one or more sensors (internally) to detect the user interaction. The set of interactions that may be interpreted by the wireless controller 100 (or more accurately, by the one or more processors via processing signals form the one or more sensors) may be referred to herein as the user interface (UI) of the wireless controller 100. FIGS. 1 and 2 illustrate the physical geometry of at least one example wireless controller in accord with those described herein. FIG. 3 is a schematic diagram of various components that may be housed internally, inside the physical enclosure, of any wireless controller in accord with those described herein.

FIG. 3 illustrates various subsystems and components associated with the wireless controller 100. Wireless controllers in accord with those described herein may include any one or more of the various subsystems and components illustrated, and not all the subsystems and components may be included in every example of a wireless controller in accord with those described herein. Similarly, various examples may also include additional subsystems and/or components illustrated.

The example wireless controller 100 illustrated in FIG. 3 includes a processor 310, which is coupled to one or more input sensors 320, one or more output indicators 330, and a power source 340. In various examples, the power source 340 may include one or more batteries, each of which may be rechargeable or may not be rechargeable in various examples. The processor 310 further includes a wireless interface 312, via which the wireless controller 100 may couple to one or more controlled devices, such as a smart device 350 and/or a peripheral 360. In at least one use case, the peripheral 360 may be coupled to the smart device 350, and user control events communicated to the smart device 350 by the wireless controller 100 cause changes in behavior of the peripheral 360, such as to adjust a playback rendering of audio or video at the peripheral 360.

According to various examples, a wireless controller in accord with those described herein may include at least one input sensor 320. The at least one input sensor 320 may detect movement, contact/touch, or other user interaction events. For example, movement, such as rotation or translation of the wireless controller, may be detected via one or more of an inertial measurement unit (IMU), an accelerometer, a gyroscope, a gravitometer, a magnetometer, or any combination of these and/or other suitable sensors. Contact or touch interactions may be detected via one or more of a touch or force sensor, for example a capacitive touch sensor or any of various force sensors that may be based upon variations in inductance, capacitance, resistance, and/or by micro electro-mechanical system (MEMS) sensor, or a piezoelectric sensor.

Based upon processing signals from the one or more input sensor(s) 320, the processor 310 may detect any of various taps and/or gestures. For example, a single tap, double tap, triple tap, or more taps, or a number of taps and hold, on the wireless controller 100 may be detected and various control messages may be sent via the wireless interface 312 based upon the detected tap sequence. For example, the wireless controller 100 may be configured to send a play/pause toggle message based upon detecting a single tap. Alternately, a control message that indicates a ‘single tap’ may be communicated, and an application on the controlled device, e.g., the smart device 350, may determine an action to be taken based upon the ‘single tap’ detected user input. In various examples, any detected user interaction (movement, touch, gesture) may be determined by the processor 310 and an appropriate action may be determined by the processor 310 and communicated via the wireless interface 312 and/or the detected user interaction may be communicated via the wireless interface 312 and a controlled device, such as the smart device 350, may determine an appropriate action to be taken based upon the detected user interaction. Any such communications sent by the processor via the wireless interface 312 may be referred to herein as command signals and/or control signals.

Detected user interaction may include any of a number of various types of interaction, such as but not limited to short taps, long taps, a certain number of taps, taps and hold, with one, two, three fingers, etc., or swipes with one, two, three fingers, etc., which may include detection of various directions (up, down, left, right), and other gestures, such as placing all fingers or palm on the top surface for a second, forming shapes other than swipes, e.g., curly-q, letters, etc. Any of these detected user interactions may also include a component of how hard the user touches the wireless controller, such as by a force sensor, which may be, for example, a micro-electro-mechanical system (MEMS) device that measures a deflection of a coupled material or surface. Detected user interaction may also include physical movement of the wireless controller, such as rotation and lateral translation, e.g., sliding or gliding, whether on a surface or through the air.

In various examples, taps may be detected by a touch sensor, force sensor, inertial measurement unit (IMU), one or more accelerometer(s), and/or a microphone, in any combination. For example, a touch sensor is not necessarily required to detect a user tap on the wireless controller. Instead, an IMU may detect the subtle motion of a user tap and the processor 310 may detect the user tap based upon the signals from the IMU, or one or more accelerometers in some examples. In some examples, the processor 310 may include a neural network or may be otherwise configured by machine learning to detect the signals to be interpreted as a tap, or any of the configured user interactions.

In at least one example, a clockwise rotation may be detected by the processor 310 and processor 310 may send a command signal via the wireless interface 312 to turn up the volume of a rendered content, or may send a command that causes the controlled device to turn up the volume. A counter-clockwise rotation may similarly send or cause a volume down command. A single tap may send or cause a play/pause command A double tap may send or cause a skip track command. A swipe may send or cause a skip track command A sliding (lateral motion) of the wireless controller may send or cause a skip track command A palm held on the top surface 110 for a period of time may send or cause a pause command and/or a mute command. A pattern drawn on the top surface 110 by a user's finger may send or cause a search command, such as the user drawing a letter on the top surface 110 and a playback application, e.g., on the smart device 350, jumps to artists' names or tracks that start with the drawn letter.

In various examples, volume controls may include controls for volume of rendered audio content and/or may include controls for levels of noise reduction and/or cancellation, e.g., “world volume.”

According to some examples, the processor 310 may detect or determine a level of gyroscopic stability of the wireless controller 100, which may distinguish intentional rotation (for control as described above) from free-space motion (such as carrying the wireless controller 100 from one location to another). Accordingly, in certain examples the processor 310 may be configured to reject various movement of the wireless controller 100 as an intentional user input, e.g., certain rotations may be determined by the processor 310 to not be intentional control inputs by the user.

In some examples, the processor 310 may be configured to detect an intentional squeeze of the wireless controller 100 via, e.g., a force sensor. In some examples, the processor 310 may be configured to detect a consequential deflection of either of the top surface 110 or side 130 (or elsewhere) when a user holds, grips, picks up, or otherwise touches the wireless controller 310, such as via a force sensor, for example.

In some examples, the processor 310 may be configured to detect when the wireless controller 100 is first touched, picked up, squeezed, or the like, via one or more of the input sensors 320, and may use such a detection to “wake up” various components and/or processing subroutines. In certain examples, one or more components, processors, and/or processing subroutines may be placed in a dormant or “sleep” state, such as to conserve power. In some examples, the dormant or sleep state may be triggered by the expiration of a threshold amount of time since the last user touch or other interaction with the wireless controller 100. For instance, an IMU, one or more accelerometers, and/or other sensors may be powered down to conserve battery life, and the processor 310 may detect user contact with the wireless controller 100 via a force sensor and/or a capacitive touch sensor, or the like, and power on the IMU, one or more accelerometers, and/or other sensors in response. Thus the wireless controller 100 may have a low power mode from which a new user touch or interaction may trigger a transition to a full power mode.

The processor 310 may be configured to enter a connection mode, a pairing mode, or a wireless discovery mode in response to various detected user interactions, in some examples. In various examples, the processor 310 may be configured to initiate a wireless connection with a nearby device based upon a signal strength of one or more wireless signals between the wireless interface 312 and the nearby device. In some examples the processor 310 may be configured to select a nearby device to communicate with (e.g., via wireless interface 312) based upon a radio signal strength, such as a Received Signal Strength Indicator (RSSI). In other examples, the processor 310 may be configured to select a device to communicate with (e.g., via wireless interface 312) based upon a more conventional priority list, or last-connected list.

In some examples, the processor 310 may provide direct feedback to a user through one or more output indicator(s) 330. For example, in response to a detected rotation, the processor may trigger a haptic force feedback component to cause the enclosure of the wireless controller to vibrate slightly. A series of such haptic feedback occurring while the user continues to rotate the wireless controller may be perceived by a user as volume knob ‘detents’ that feel similar to other audio equipment having tactile feedback upon turning a knob. Various lights or display components integrated into the top surface 110 or side 130 (or elsewhere) may be included as output indicator(s) 330, e.g., used to indicate a detected user interaction and/or other operating characteristic(s) such as being connected to the controlled device, being in pairing mode to discover or connect to a new controlled device, a low battery condition or battery charging condition, etc. In some examples, an output indicator includes an acoustic transducer, such as a small speaker, to provide audible feedback to the user.

According to some examples, an infrared (IR) interface may be included (and coupled to the processor 312). Such an IR interface may include one or more infrared transmitters and/or infrared receivers. The processor 312 may be configured to send one or more IR command signals in response to a detected user interaction, such as to provide backward compatibility with existing home audio/theatre equipment. The processor 312 may be configured to receive one or more IR command signals, such as for programming or learning of IR commands, triggering a pairing procedure, etc.

In general, examples of wireless controllers disclosed herein may include a capability to be configured, e.g., to establish user preferences, defaults, manage paired devices lists, trigger pairing, map detected user interactions to desired command signals, update firmware, etc., via any of numerous means, e.g., via the wireless interface 312 and/or a wired connector, etc., through which the processor 312 may communicate with an application or other controller (or controlled device).

In various examples, the processor 312 may include one or more processors and may include machine executable instructions encoded in a memory that, when executed by the processor 312, causes the processor 312 to operate as variously described.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A wireless controller device comprising:
an enclosure having a top and a bottom, each of the top and the bottom having a substantially circular perimeter, and a side having a height circumferentially around the perimeter of the top and the bottom and coupling the top with the bottom;
a first sensor coupled to the enclosure;
a processor coupled to the first sensor and configured to process signals from the first sensor; and
a wireless interface coupled to the processor, the processor further configured to control the wireless interface to send one or more command signals via the wireless interface, the command signals based at least upon the signals from the first sensor,
wherein the processor is configured to detect one or more user taps on the enclosure via at least the signals from the first sensor, and to control the wireless interface to send one or more command signals configured to control an audio signal based at least in part upon the one or more user taps.

2. The wireless controller device of claim 1 wherein the first sensor includes at least one of an inertial measurement unit (IMU), an accelerometer, a gyroscope, a gravitometer, a microphone, a touch sensor, and a magnetometer.

3. The wireless controller device of claim 1 further comprising a material coupled to the bottom and configured to provide a coefficient of friction with a surface in contact with the material.

4. The wireless controller device of claim 1 further comprising a wall plate configured to accommodate and removably couple with the bottom.

5. The wireless controller device of claim 4 further comprising a magnet that provides the removable coupling.

6. The wireless controller device of claim 1 further comprising a second sensor configured to detect contact with at least one of the top, bottom, and side by a user, the processor further configured to process signals from the second sensor and to control the wireless interface to send command signals based at least upon the signals from the second sensor.

7. The wireless controller device of claim 6 wherein the second sensor includes at least one of a capacitive touch sensor and a force sensor.

8. The wireless controller device of claim 6 wherein the second sensor detects an amount of force exerted by the user via at least one of an inductance sensor, a capacitance sensor, a micro electro-mechanical system (MEMS), and a piezoelectric sensor.

9. The wireless controller device of claim 6 wherein the command signals are based at least upon a detected gesture by the user.

10. The wireless controller device of claim 1 wherein the command signals include one or more of pause, play, skip forward, skip backward, volume up, volume down, mute, and initiate pairing.

11. The wireless controller device of claim 1 further comprising a vibration device coupled to the processor, the processor further configured to control the vibration device to provide haptic feedback to the user.

12. The wireless controller device of claim 11 wherein the haptic feedback to the user includes at least a perceived detent in response to rotation.

13. The wireless controller device of claim 1 wherein the processor is configured to initiate a wireless connection by monitoring the wireless interface for a nearby device based upon a signal strength of one or more wireless signals between the wireless interface and the nearby device.

14. The wireless controller device of claim 13 wherein the nearby device is selected by the processor as a device having the highest signal strength.

15. The wireless controller device of claim 13 wherein the signal strength is indicated by a wireless message that includes a received signal strength indicator (RSSI).

16. The wireless controller device of claim 13 wherein the processor is configured to initiate the wireless connection in response to at least one of a detected user gesture, a detected proximity to the nearby device, a power-on event, a detected lack of configuration settings, and a detected physical contact with the nearby device.

17. The wireless controller device of claim 1 further comprising an infrared (IR) interface coupled to the processor and configured to send or receive infrared signals.

18. The wireless controller device of claim 1 wherein the processor is further configured to determine a gyroscopic stability of a detected movement and to control the wireless interface to send the one or more command signals based upon the determination.
